(19) United States
(12) Patent Application Publication
(10) Pub. No.: US 2026/0219384 A1
(43) Pub. Date: Jul. 30, 2026

(54) INFORMATION PROCESSING DEVICE, INFORMATION PROCESSING METHOD, AND NON-TRANSITORY COMPUTER-READABLE MEDIUM

(71) Applicant: NEC Corporation, Tokyo (JP)

(72) Inventors: Takashi SHIBATA, Tokyo (JP); Kosuke KINOSHITA, Tokyo (JP); Jianquan LIU, Tokyo (JP)

(73) Assignee: NEC Corporation, Tokyo (JP)

(21) Appl. No.: 19/146,014

(22) PCT Filed: Feb. 13, 2024
(86) PCT No.: PCT/JP2024/004800

§ 371 Date: Jul. 7, 2025

(30) Foreign Application Priority Data
Mar. 30, 2023 (JP) 2023-055108

(51) Int. Cl. G01S 13/89

(52) U.S. Cl. CPC G01S 13/89

(57) ABSTRACT

This information processing device comprises a reflected wave processing unit and an order determination unit. The reflected wave processing unit processes reflected wave information to detect a plurality of target regions. The reflected wave information indicates a reflected wave of an electromagnetic wave projected toward a subject region. The target regions are regions, in the subject region, in which an object may be present. The order determination unit uses the respective positions of the plurality of target regions to determine a recommended investigation order for reinvestigation as to whether the object is present.

### TECHNICAL FIELD

The present invention relates to an information processing device, an information processing method, and a recording medium.

### BACKGROUND ART

As a device configured to detect an object buried in the ground, for example, there is a device described in PTL 1. This device is a device configured to detect a landmine. Specifically, a sensor head is provided with a transmitting unit and a receiving unit. The transmitting unit transmits an impulse of an electromagnetic wave toward the ground where a landmine is to be detected, and the receiving unit receives a reflected wave from the landmine. Then, the device generates information indicating a three-dimensional structure of the landmine based on a time until the reflected wave is received, a reception level of the reflected wave, and a position of the sensor head, and displays the information on a display unit.

Furthermore, PTL 2 describes a device configured to search for a lost mobile body. The device acquires a radio wave intensity of a radio wave transmitted from a transmitter provided in the lost mobile body, and position and altitude at which the radio wave is received from an unmanned aerial vehicle for searching for the lost mobile body. Then, the device generates a visualized graph by coloring the coordinates of a map image corresponding to the position according to the radio wave intensity, inputs the visualized graph to an estimation model, and estimates the position of the lost mobile body.

In addition, PTL 3 describes a self-propelled robot configured to search for a position of an interference source of an electromagnetic wave while moving among a plurality of measurement points that are predetermined positions in a search target region. The robot determines a travel route for searching for an oscillation source of an electromagnetic wave based on information detected and measured by a topography, obstacle, and position detection sensor unit and measurement data measured by a radio wave measurement unit, and controls self-propellent.

In addition, PTL 4 discloses a search assistance device configured to acquire positions and reception intensities of a plurality of wireless terminals based on received radio waves from the plurality of wireless terminals, extracts a wireless terminal corresponding to a position included in a disaster-stricken area among the acquired positions as a wireless terminal to be searched, and displays a search range at a position corresponding to the extracted wireless terminal with a degree of emphasis corresponding to the corresponding reception intensity.

### CITATION LIST

### Patent Literatures

PTL 1: WO 2000/023762 A1
PTL 2: JP 2023-019847 A
PTL 3: JP 2019-215183 A
PTL 4: WO 2018/179436 A1

### SUMMARY OF INVENTION

### Technical Problem

In a case where the region where the presence or absence of the object is to be investigated is a wide region, a large amount of labor is often required when the entire region is investigated. In the methods described in PTLs 1 to 4 described above, it is difficult to reduce this labor. In view of the above-described problems, an object of the present invention is to provide an information processing device, an information processing method, and a recording medium capable of reducing labor required at the time of investigation even in a case where a region to be investigated is a wide region.

### Solution to Problem

A first information processing device according to the present disclosure includes:
a reflected wave processing means for processing reflected wave information indicating a reflected wave of an electromagnetic wave applied to a subject region to detect a plurality of target regions that are regions where an object has a possibility of existing in the subject region, and
an order determination means for determining a recommended investigation order in a case where whether the object exists is investigated again by using positions of each of the plurality of target regions.

Furthermore, a second information processing device according to the present disclosure includes:
a reflected wave processing means for processing reflected wave information indicating a reflected wave of an electromagnetic wave applied to a subject region to detect a plurality of target regions that are regions where an object has a possibility of existing in the subject region, and
an output means for generating and outputting map information in which positions of the plurality of target regions are displayed.

A first information processing method according to the present disclosure includes:
by a computer
processing reflected wave information indicating a reflected wave of an electromagnetic wave applied to a subject region to detect a plurality of target regions that are regions where an object has a possibility of existing in the subject region, and
determining a recommended investigation order in a case where whether the object exists is investigated again by using positions of each of the plurality of target regions.

Furthermore, a second information processing method according to the present disclosure includes:
by a computer
processing reflected wave information indicating a reflected wave of an electromagnetic wave applied to a subject region to detect a plurality of target regions that are regions where an object has a possibility of existing in the subject region, and
generating and outputting map information in which positions of the plurality of target regions are displayed.

A first computer-readable recording medium according to the present disclosure is recorded with a program for causing a computer to execute operations including:
processing reflected wave information indicating a reflected wave of an electromagnetic wave applied to a subject region to detect a plurality of target regions that are regions where an object has a possibility of existing in the subject region, and
determining a recommended investigation order in a case where whether the object exists is investigated again by using positions of each of the plurality of target regions.

Furthermore, a second computer-readable recording medium according to the present disclosure is recorded with a program for causing a computer to execute operations including:
processing reflected wave information indicating a reflected wave of an electromagnetic wave applied to a subject region to detect a plurality of target regions that are regions where an object has a possibility of existing in the subject region, and
generating and outputting map information in which positions of the plurality of target regions are displayed.

### Advantageous Effects of Invention

According to one aspect of the present invention, a labor required at the time of investigation can be reduced even in a case where a region to be investigated is a wide region.

### BRIEF DESCRIPTION OF DRAWINGS

FIG. 1 It is a diagram illustrating an outline of an information processing device according to a first example embodiment.

FIG. 2 It is a diagram for describing a usage environment of the information processing device.

FIG. 3 It is a diagram illustrating an example of a functional configuration of a measurement device.

FIG. 4 It is a diagram illustrating an example of a functional configuration of the information processing device.

FIG. 5 It is a diagram for describing an example of a process performed by a two-dimensional information generation unit.

FIG. 6 It is a diagram for describing an example of a process performed by an order determination unit.

FIG. 7 It is a diagram illustrating a hardware configuration example of the information processing device.

FIG. 8 It is a flowchart illustrating an example of a process performed by the information processing device.

FIG. 9 It is a diagram illustrating an example of a functional configuration of an information processing device according to a second example embodiment.

FIG. 10 It is a diagram illustrating an outline of an information processing device according to a third example embodiment.

FIG. 11 It is a diagram illustrating an example of a functional configuration of the information processing device.

### EXAMPLE EMBODIMENTS

Hereinafter, example embodiments of the present invention will be described with reference to the drawings. In all the figures, the same components are denoted by the same reference numerals, and the description thereof will be omitted as appropriate.

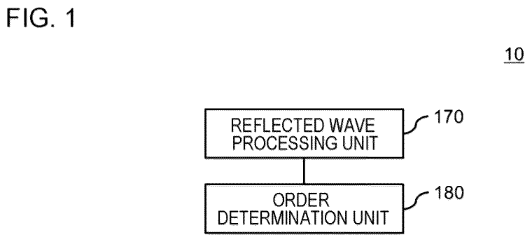

FIG. 1 is a diagram illustrating an outline of an information processing device 10 according to a first example embodiment. This information processing device 10 includes a reflected wave processing unit 170 and an order determination unit 180. The reflected wave processing unit 170 processes reflected wave information to detect a plurality of target regions. The reflected wave information indicates a reflected wave of an electromagnetic wave applied to a subject region. The target region is a region having a possibility of an object existing in the subject region. The order determination unit 180 determines a recommended investigation order for re-investigating as to whether the object exists by using each of the positions of the plurality of target regions.

The user of the information processing device 10 first detects a plurality of target regions by generating reflected wave information and causing the information processing device 10 to process the reflected wave information. Then, in a case where whether the object exists is investigated again, the user of the information processing device 10 may perform investigation according to the recommended investigation order. Therefore, when the information processing device 10 is used, the labor required at the time of investigation can be reduced even in a case where the region to be investigated is a wide region.

Hereinafter, a detailed example of the information processing device 10 will be described.

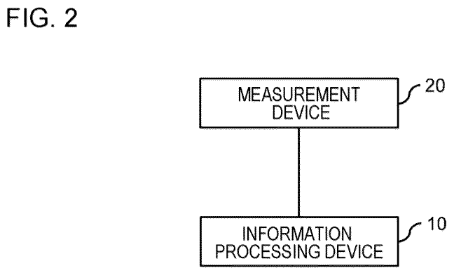

FIG. 2 is a diagram for describing a usage environment of the information processing device 10. The information processing device 10 is used together with a measurement device 20.

The measurement device 20 is a device that can be remotely operated. The measurement device 20 may be, for example, a flying object such as a drone or a self-propelled device. The measurement device 20 can be moved automatically or by remote operation. In addition, the subject region where the presence or absence of an object is to be investigated is, for example, the ground and an underground under the ground. In this case, the object exists on the ground or in the underground.

The measurement device 20 generates reflected wave information while moving in a region where the presence or absence of an object is to be investigated, and transmits the reflected wave information to the information processing device 10 via, for example, a wireless communication network. This transmission is performed, for example, in real time, but may be performed in a batch manner.

The information processing device 10 detects the target region by processing the reflected wave information received from the measurement device 20. The information processing device 10 may perform this process in a batch manner, or may perform the process in real time, that is, every time the reflected wave information is received from the measurement device 20.

The information used to detect the target region is the reflected wave information generated by the measurement device 20. There is a high possibility that the reflected wave information includes noise. Therefore, it is desirable to re-examine whether the object actually exists in the target region. The re-examination is preferably performed using a device with relatively high accuracy, such as a metal detector. The labor required for the re-examination is high as compared with the examination using the information processing device 10 and the measurement device 20. Therefore, in a case where a plurality of target regions are detected, the information processing device 10 determines a recommended investigation order in a case where whether an object exists is investigated again by using the position of each of the plurality of target regions.

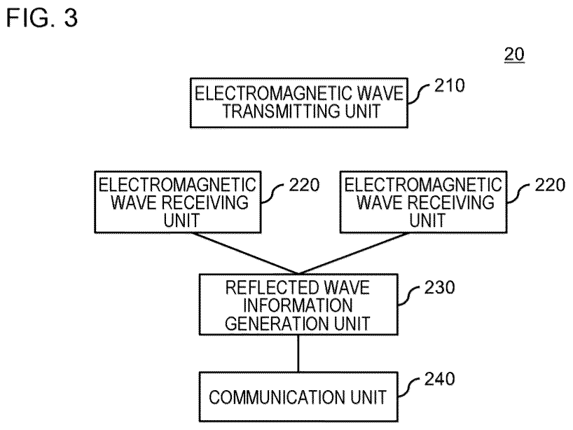

FIG. 3 is a diagram illustrating an example of a functional configuration of the measurement device 20. The measurement device 20 includes an electromagnetic wave transmitting unit 210, an electromagnetic wave receiving unit 220, a reflected wave information generation unit 230, and a communication unit 240. The measurement device 20 includes a movement mechanism for moving the measurement device 20 and a movement control unit for controlling the movement mechanism, in addition to the configuration illustrated in FIG. 3.

The electromagnetic wave transmitting unit 210 emits the electromagnetic wave toward the subject region. The electromagnetic wave is, for example, a millimeter wave, and an example of a wavelength thereof is equal to or more than 0.3 GHz and equal to or less than 300 GHz. However, the band of the electromagnetic wave irradiated by the electromagnetic wave transmitting unit 210 is not limited to the millimeter wave. The transmission method used by the electromagnetic wave transmitting unit 210 is, for example, any of frequency modulated continuous wave (FMCW), pulse, continuous wave (CW) Doppler, 2 frequency CW, and pulse compression, but may be other methods.

The electromagnetic wave receiving unit 220 receives a reflected wave of the electromagnetic wave irradiated by the electromagnetic wave transmitting unit 210. This reflected wave is an electromagnetic wave reflected by, for example, an object on the ground surface or an object in the ground. In other words, if an object that reflects an electromagnetic wave exists in the subject region, the intensity of the reflected wave increases. The object that reflects the electromagnetic wave is mainly formed of metal in many cases.

In the example illustrated in the figure, a plurality of, for example, two electromagnetic wave receiving units 220 are provided. The plurality of electromagnetic wave receiving units 220 are separated from each other, and receive the reflected wave of the electromagnetic wave irradiated by the same electromagnetic wave transmitting unit 210. In this way, the detection accuracy of the target region by the information processing device 10 becomes high.

The reflected wave information generation unit 230 generates the reflected wave information using the reception result by the electromagnetic wave receiving unit 220. The reflected wave information includes, for example, time-series information of the intensity of the reflected wave. The time-series information includes a combination of the reception date and time of the reflected wave and the intensity of the reflected wave at that time. In a case where the plurality of electromagnetic wave receiving units 220 are provided, the reflected wave information generation unit 230 generates the reflected wave information for each of the plurality of electromagnetic wave receiving units 220.

Furthermore, the reflected wave information generation unit 230 generates position information indicating the position of the measurement device 20. This position information may be generated using, for example, GPS, or may be generated using another method, for example, simultaneous localization and mapping (SLAM). Then, the reflected wave information generation unit 230 adds, to the reflected wave information, position information of the measurement device 20 at the time of receiving the reflected wave.

The communication unit 240 communicates with an external device. As an example, the communication unit 240 transmits the reflected wave information generated by the reflected wave information generation unit 230 to the information processing device 10. This transmission may be in a batch manner or in real time as described above. As another example, the communication unit 240 receives information for controlling the movement of the measurement device 20, for example, route information indicating a route the measurement device is to move. In this case, the movement control unit of the measurement device 20 controls the movement mechanism of the measurement device 20 to move the measurement device 20 according to the received route information.

The position information may be information separate from the reflected wave information. In this case, the position information is time-series information of the position of the measurement device 20. The time-series information includes a combination of date and time and a position of the measurement device 20 at that date and time. In this case, the communication unit 240 also transmits the position information to the information processing device 10.

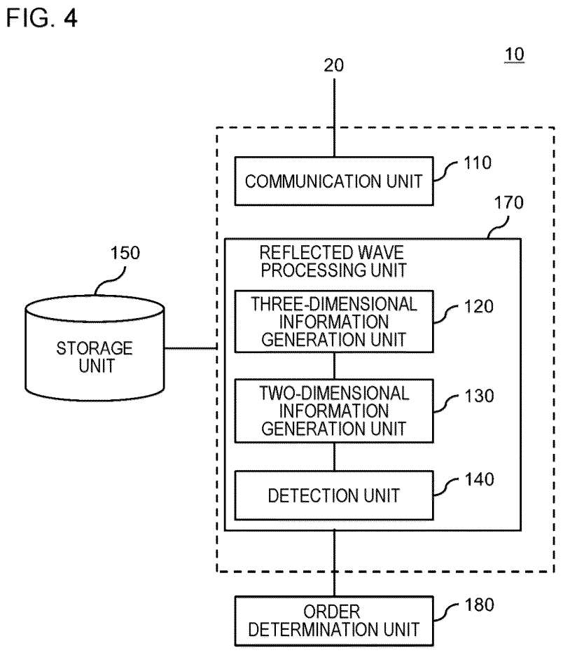

FIG. 4 is a diagram illustrating an example of a functional configuration of the information processing device 10. The information processing device 10 includes a communication unit 110 and a storage unit 150 in addition to the reflected wave processing unit 170 and the order determination unit 180 illustrated in FIG. 1.

The communication unit 110 communicates with an external device, for example, the measurement device 20. For example, when receiving the reflected wave information from the measurement device 20, the communication unit 110 stores the reflected wave information in the storage unit 150. When the position information is transmitted from the measurement device 20, the communication unit 110 also stores the position information in the storage unit 150.

Furthermore, the information processing device 10 includes a three-dimensional information generation unit 120, a two-dimensional information generation unit 130, and a detection unit 140 as the reflected wave processing unit 170.

As described with reference to FIG. 1, the three-dimensional information generation unit 120 generates three-dimensional information by processing the reflected wave information. Specifically, the reflected wave information includes the intensity of the reflected wave and the time-series signal of the position of the measurement device 20. For example, the three-dimensional information generation unit 120 performs fast Fourier transform (FFT) on the reflected wave constituting the time-series signal a plurality of times, thereby calculating the distance from the electromagnetic wave receiving unit 220 to the reflection point that is the starting point of the reflected wave. In a case where there are a plurality of electromagnetic wave receiving units 220, the three-dimensional information generation unit 120 performs this process for each electromagnetic wave receiving unit 220. Then, the three-dimensional information generation unit 120 calculates an estimation value of the intensity of the reflected wave for at least one first point included in the three-dimensional space corresponding to the subject region by integrating a plurality of distances based on the reflected waves measured by the different electromagnetic wave receiving units 220 at the same timing. Then, the three-dimensional information generation unit 120 performs this process on the reflected wave measured at a plurality of timings to calculate an estimation value of the intensity of the reflected wave for each of the plurality of first points, and sets the estimation values as three-dimensional information. This estimation value can be regarded as a value indicating the possibility that the object exists at the first point. Hereinafter, this value is referred to as a first value. However, a method of generating the three-dimensional information, for example, a method of generating the first value is not limited to this example.

As described with reference to FIG. 1, the two-dimensional information generation unit 130 generates two-dimensional information by projecting three-dimensional information on a predetermined plane. Hereinafter, this predetermined plane is referred to as a projection surface. The angle formed by the projection surface with respect to the ground of the subject region is preferably equal to or less than 10°. That is, the projection surface is preferably horizontal to the ground of the subject region.

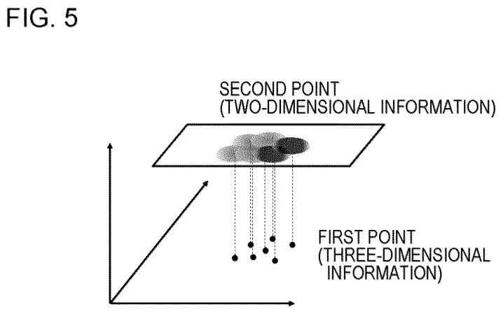

FIG. 5 is a diagram for describing an example of a process performed by the two-dimensional information generation unit 130. The two-dimensional information generation unit 130 specifies a plurality of first points corresponding to a second point. For example, the two-dimensional information generation unit 130 sets a plurality of first points overlapping with the second point as first points corresponding to the second point when viewed from a direction perpendicular to the projection surface. Next, the two-dimensional information generation unit 130 specifies a first value corresponding to each of the plurality of specified first points, and generates a second value indicating the possibility that the object exists at the second point by using the first value. The second value may be a maximum value or an average value of the plurality of first values. In addition, as the second value, a first value corresponding to a first point closest to the ground surface among the first points at which the first value exceeds the reference value may be set as the second value. Then, the two-dimensional information generation unit 130 sets the second value for each second point as the two-dimensional information. In other words, the two-dimensional information can be regarded as black and white image data.

Returning to FIG. 4. As described with reference to FIG. 1, the detection unit 140 detects the target region by processing the two-dimensional information. For example, the detection unit 140 detects the target region by performing predetermined image processing on the two-dimensional information. This image processing is, for example, YOLO, Single Shot MultiBox Detector (SSD), or Faster Regions with Convolutional Neural Networks (RCNN), but may be other processing.

The reflected wave processing unit 170 may detect the target region using at least one of geological information of the subject region and weather information when the reflected wave is generated. For example, the geology of a specific region of the subject region may be likely to generate a reflected wave. In addition, depending on the weather, water or snow may accumulate on the ground surface in the subject region, affecting the reflected wave. The reflected wave processing unit 170 reflects this influence when selecting the target region.

For example, at least one of the three-dimensional information generation unit 120 and the two-dimensional information generation unit 130 generates three-dimensional information or two-dimensional information by multiplying the first value or the second value by a parameter corresponding to the geology of the place. This parameter is set in advance. Furthermore, at least one of the three-dimensional information generation unit 120 and the two-dimensional information generation unit 130 generates three-dimensional information or two-dimensional information by multiplying the first value or the second value by a parameter corresponding to the weather at the time of measurement. This parameter is also set in advance.

The geological information and the weather information are input to the information processing device 10 by the user of the information processing device 10, for example, but the information processing device 10 may acquire the information from a database storing the same.

Furthermore, the detection process of the target region performed by the reflected wave processing unit 170 is not limited to the above example.

Then, in a case where a plurality of target regions are detected, the order determination unit 180 determines a recommended investigation order in a case of re-investigating whether an object exists by using the position of each of the plurality of target regions. At this time, the order determination unit 180 acquires map data of the subject region as necessary.

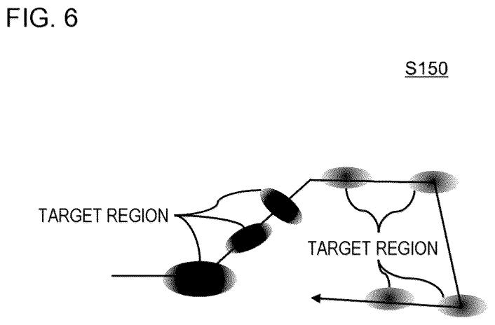

FIG. 6 is a diagram for describing an example of a process performed by the order determination unit 180. In the example illustrated in the figure, the plurality of target regions are superimposed on the map. Then, the recommended investigation order of the plurality of target regions is set using, for example, a well-known route setting method based on the traveling salesman problem.

The order determination unit 180 may display a screen illustrated in this figure on the display. This screen displays a map together with a plurality of target regions. Specifically, the order determination unit 180 displays a mark indicating a target region in a portion corresponding to the target region in the map. This mark indicates, for example, the second value, that is, the possibility that the object exists in the target region. As an example, this mark is a heat map based on the second value, but is not limited thereto. Then, the order determination unit 180 causes information indicating the recommended investigation order, for example, a line or an arrow, to be displayed in a superimposed manner on the map.

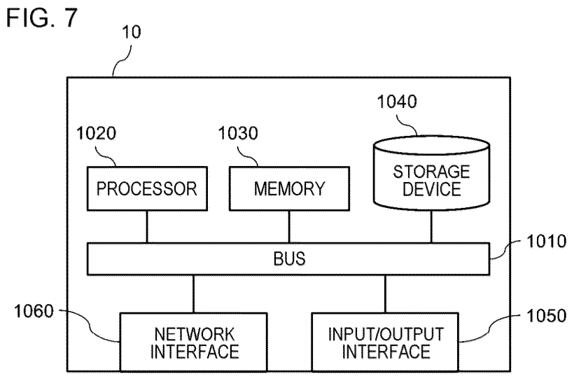

FIG. 7 is a diagram illustrating a hardware configuration example of the information processing device 10. The information processing device 10 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, the method of connecting the processor 1020 and the like to each other is not limited to the bus connection.

The processor 1020 is a processor achieved by a central processing unit (CPU), a graphics processing unit (GPU), or the like.

The memory 1030 is a main storage device achieved by a random access memory (RAM) or the like.

The storage device 1040 is an auxiliary storage device achieved by a removable medium such as a hard disk drive (HDD), a solid state drive (SSD), and a memory card, or a read only memory (ROM), and has a recording medium. The recording medium of the storage device 1040 stores program modules that achieve each function (e.g., the communication unit 110, the three-dimensional information generation unit 120, the two-dimensional information generation unit 130, the detection unit 140, and the order determination unit 180) of the information processing device 10. The processor 1020 reads and executes the program modules on the memory 1030, thereby implementing the functions corresponding to the program modules. Furthermore, the storage device 1040 also functions as the storage unit 150.

The input/output interface 1050 is an interface for connecting the information processing device 10 and various input/output devices.

The network interface 1060 is an interface for connecting the information processing device 10 to a network. The network is, for example, a local area network (LAN) or a wide area network (WAN). A method of connecting the network interface 1060 to the network may be a wireless connection or a wired connection. The information processing device 10 may communicate with the measurement device 20 via the network interface 1060.

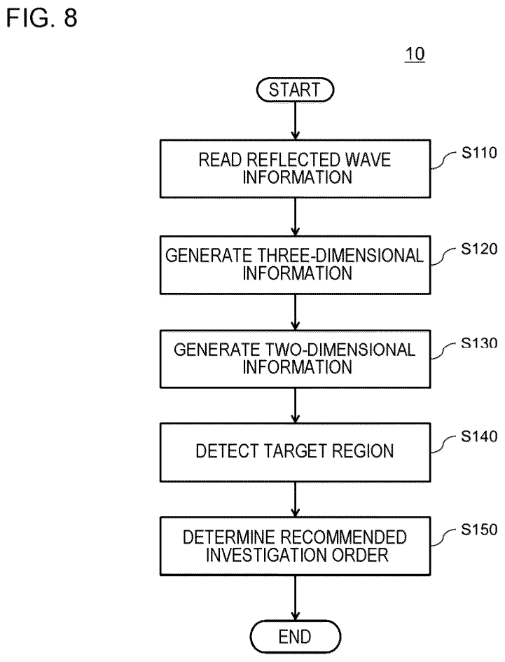

FIG. 8 is a flowchart illustrating an example of a process performed by the information processing device 10. In the example illustrated in this figure, the information processing device 10 performs the process in a batch manner.

Apart from the process illustrated in the figure, the communication unit 110 repeatedly acquires reflected wave information from the measurement device 20 and stores the information in the storage unit 150.

First, the three-dimensional information generation unit 120 reads the reflected wave information of the subject region to be the current processing target from the storage unit 150 (step S110), and generates three-dimensional information by processing the read reflected wave information (step S120). Next, the two-dimensional information generation unit 130 generates two-dimensional information by processing the three-dimensional information (step S130).

Next, the detection unit 140 detects the target region by processing the two-dimensional information. The target region is data indicating a region where the possibility of the object existing is high on a two-dimensional plane (step S140). Here, the detection unit 140 may use, as the information indicating the target region, information in which the coordinate of the second point is associated with the probability (reliability) that the object exists at that coordinate. The probability used here is the second value, but may be a value obtained by processing the second value. Furthermore, the detection unit 140 may generate, for each coordinate of the projection surface, information in which the probability (reliability) that the object exists at that coordinate is associated. The detection unit 140 may cause the display device to display a screen indicating the target region. The display device may be a part of the information processing device 10 or may be exterior to the information processing device 10.

Then, the order determination unit 180 determines the recommended investigation order (step S150).

As described above, according to the present example embodiment, the reflected wave processing unit 170 of the information processing device 10 detects a plurality of target regions by processing the reflected wave information. Then, the order determination unit 180 of the information processing device 10 determines the recommended investigation order in the case of re-investigating whether the object exists by using the position of each of the plurality of target regions. Therefore, by using the information processing device 10 is used, the labor required at the time of investigation can be reduced even in a case where the region to be investigated is a wide region.

### Second Example Embodiment

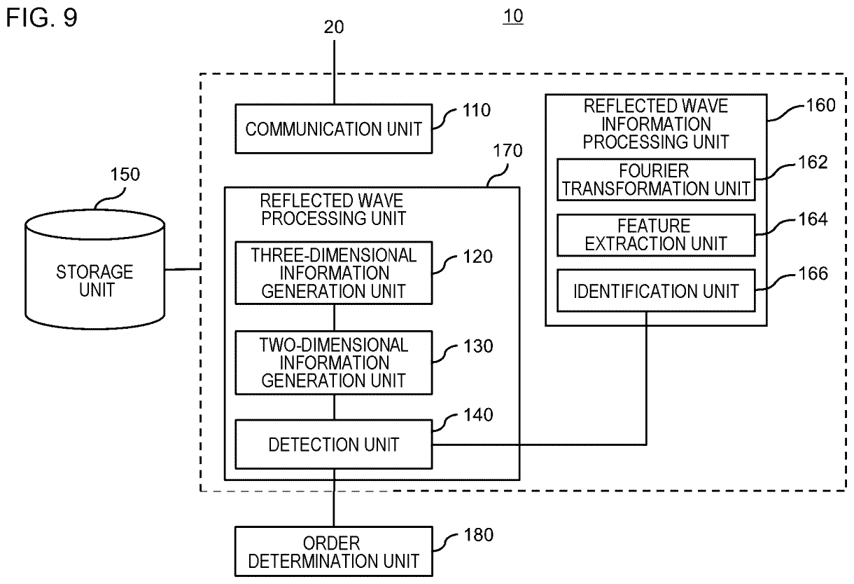

FIG. 9 is a diagram illustrating an example of a functional configuration of an information processing device 10 according to a second example embodiment, and corresponds to FIG. 4 of the first example embodiment. The information processing device 10 according to the present example embodiment has the configuration similar to that of the information processing device 10 according to the first example embodiment except for the following points.

First, the information processing device 10 includes a reflected wave information processing unit 160. The reflected wave information processing unit 160 processes the reflected wave information by using a model generated by machine learning. Then, the detection unit 140 detects the target region using the two-dimensional information generated by the two-dimensional information generation unit 130 and the processing result by the reflected wave information processing unit 160.

Specifically, the reflected wave information processing unit 160 includes a Fourier transformation unit 162, a feature extraction unit 164, and an identification unit 166. The Fourier transformation unit 162 generates a frequency signal by performing Fourier transformation on the reflected wave information. An example of the frequency signal is a spectrogram or a mel-spectrogram, but is not limited thereto.

The feature extraction unit 164 extracts a feature by processing the frequency signal generated by the Fourier transformation unit 162 using a first model. Specifically, the feature extraction unit 164 selects data corresponding to a first point included in the three-dimensional information among the frequency signals. The first point included in the three-dimensional information is associated with the generation timing of the reflected wave information corresponding to the first point. Therefore, the feature extraction unit 164 can select a frequency signal corresponding to this generation timing. Then, the feature extraction unit 164 extracts a feature by inputting the frequency signal to the first model generated by machine learning. The first model is generated by machine learning, for example, with a frequency signal as an explanatory variable and a feature as an objective variable. An example of the machine learning used here is a convolutional neural network, but is not limited thereto.

The identification unit 166 detects a region that can be a target region by processing the feature extracted by the feature extraction unit 164 using a second model. Specifically, the second model is, for example, a discriminator according to a fully coupled deep learning network. Then, when determined by the discriminator that the input feature is abnormal (e.g., in a case where the certainty of being the target region is equal to or more than a reference value), the identification unit 166 determines that the first point corresponding to the input feature is the region where the object exists, that is, the target region. Then, the first point is projected onto the projection surface by the same method as that of the two-dimensional information generation unit 130 to specify the target region in the two-dimensional information. At this time, the identification unit 166 also preferably associates the certainty (reliability) of the target region for each coordinate on the projection surface serving as a basis of the two-dimensional information.

The detection unit 140 then detects a target region using the method described in the first example embodiment, and integrates the target region and the target region detected using the identification unit 166 to detect a final target region. For example, the detection unit 140 may calculate a weighted average value of the reliability for each coordinate calculated by the method described in the first example embodiment and the reliability for each coordinate generated by the identification unit 166, and set a region where the average value is equal to or more than a threshold value as a final target region. In addition, the detection unit 140 may set a union or a product set of the target region calculated by the method described in the first example embodiment and the target region generated by the identification unit 166 as a final target region.

In the present example embodiment as well, as in the first example embodiment, the labor required at the time of investigation is small even in a case where the region to be investigated is a wide region. In addition, since the reflected wave information processing unit 160 is provided, the detection accuracy of the target region is enhanced.

### Third Example Embodiment

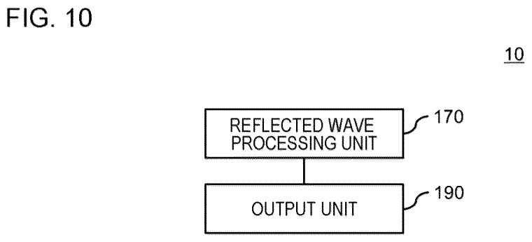

FIG. 10 is a diagram illustrating an outline of an information processing device 10 according to a third example embodiment. The information processing device 10 according to the present example embodiment includes a reflected wave processing unit 170 and an output unit 190. The reflected wave processing unit 170 performs the process similar to that of the first or second example embodiment. Then, the output unit 190 generates and outputs map information in which the positions of the plurality of target regions are displayed. An example of the information output here is information excluding an arrow indicating a recommended order from FIG. 6.

The user of the information processing device 10 can refer to the map information when creating a re-investigation plan for a plurality of target regions. Therefore, even in a case where the region to be investigated is a wide region, the labor required at the time of investigation can be reduced.

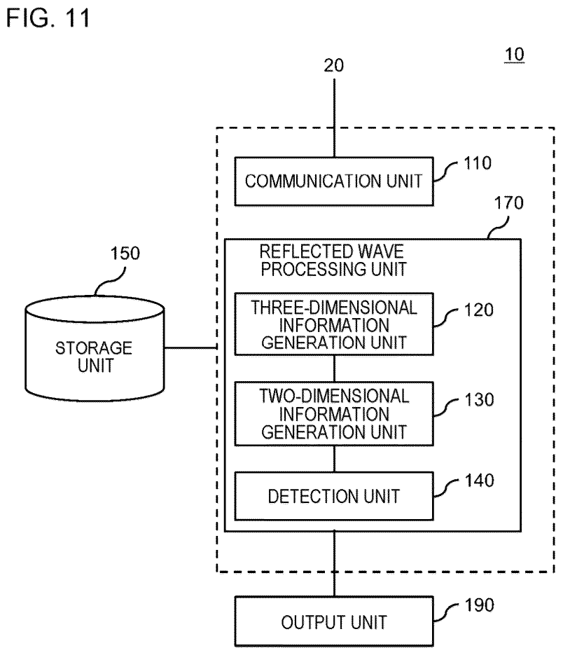

FIG. 11 is a diagram illustrating an example of a functional configuration of the information processing device 10. In the example illustrated in the figure, the information processing device 10 is similar to the example illustrated in FIG. 4 except that an output unit 190 is included instead of the order determination unit 180. The information processing device 10 may include the output unit 190 instead of the order determination unit 180 in the example illustrated in FIG. 9.

Here, the output unit 190 may output a screen including an input field for allowing the user to input information for specifying a recommended investigation order in a case where whether an object exists is investigated again and map information to display on the display. The recommended investigation order input to the input field is determined by the user after visually recognizing the map output by the output unit 190. The input field described above may also serve as a region where a map is displayed. In this case, the user of the information processing device 10 sequentially selects the target region on this screen. This selection order is the information indicating the recommended investigation order.

According to the present example embodiment, the user of the information processing device 10 can refer to the map information when creating a re-investigation plan for a plurality of target regions. Therefore, even in a case where the region to be investigated is a wide region, the labor required at the time of investigation can be reduced. Furthermore, in a case where the output unit 190 causes the display to display a screen including the input field for inputting information for specifying the recommended investigation order and the map information, the user of the information processing device 10 can easily set the recommended investigation order.

Although the example embodiments of the present invention have been described above with reference to the drawings, these are examples of the present invention, and various configurations other than the above can be adopted.

In addition, in the flowchart used in the above description, a plurality of steps (processes) are described in order, but the execution order of the steps executed in each example embodiment is not limited to the described order. In each example embodiment, the order of the illustrated steps can be changed within a range in which problems do not arise in terms of content. Furthermore, the example embodiments described above can be combined within a range in which the contents are not contradictory.

Some or all of the example embodiments described above may be described as the following Supplementary Notes, but are not limited to the following.
1. An information processing device including:
a reflected wave processing means for processing reflected wave information indicating a reflected wave of an electromagnetic wave applied to a subject region to detect a plurality of target regions that are regions where an object has a possibility of existing in the subject region, and
an order determination means for determining a recommended investigation order in a case where whether the object exists is investigated again by using positions of each of the plurality of target regions.
2. The information processing device according to the above 1, in which
a frequency of the electromagnetic wave is equal to or more than 0.3 GHz and equal to or less than 300 GHz.
3. The information processing device according to the above 1 or 2, in which
the reflected wave information is generated by a flying object or a self-propelled device including an irradiation means for applying the electromagnetic wave and a receiving means for receiving the reflected wave.
4. The information processing device according to any one of the above 1 to 3, in which
the reflected wave processing means includes:
a three-dimensional information generation means for processing reflected wave information indicating a reflected wave of an electromagnetic wave applied to a subject region to generate three-dimensional information indicating a possibility that an object exists for a plurality of first points included in a three-dimensional space corresponding to the subject region,
a two-dimensional information generation means for projecting the three-dimensional information onto a predetermined plane to generate two-dimensional information indicating a possibility that the object exists for each of a plurality of second points included in the plane, and
a detection means for processing the two-dimensional information to detect a target region that is a region where the object has a possibility of existing in the subject region.
5. The information processing device according to any one of the above 1 to 4, in which
the subject region is a ground and an underground under the ground, and
the object exists on the ground or in the underground.
6. The information processing device according to any one of the above 1 to 5, wherein
the reflected wave processing means detects the plurality of target regions further by using at least one of geological information of the subject region and weather information when the reflected wave corresponding to each of the plurality of target regions is generated.
7. An information processing device including:
a reflected wave processing means for processing reflected wave information indicating a reflected wave of an electromagnetic wave applied to a subject region to detect a plurality of target regions that are regions where an object has a possibility of existing in the subject region, and
an output means for generating and outputting map information in which positions of the plurality of target regions are displayed.
8. The information processing device according to the above 7, in which
the output means outputs a screen including an input field for inputting information for specifying a recommended investigation order in a case where whether the object exists is investigated again and the map information to be displayed on a display.
9. An information processing method including:
by a computer
processing reflected wave information indicating a reflected wave of an electromagnetic wave applied to a subject region to detect a plurality of target regions that are regions where an object has a possibility of existing in the subject region, and
determining a recommended investigation order in a case where whether the object exists is investigated again by using positions of each of the plurality of target regions.
10. The information processing method according to the above 9, in which
a frequency of the electromagnetic wave is equal to or more than 0.3 GHz and equal to or less than 300 GHz.
11. The information processing method according to the above 9 or 10, in which
the reflected wave information is generated by a flying object or a self-propelled device including an irradiation means for applying the electromagnetic wave and a receiving means for receiving the reflected wave.
12. The information processing method according to any one of the above 9 to 11, further including:
by the computer
processing reflected wave information indicating a reflected wave of an electromagnetic wave applied to a subject region to generate three-dimensional information indicating a possibility that an object exists for a plurality of first points included in a three-dimensional space corresponding to the subject region,
projecting the three-dimensional information onto a predetermined plane to generate two-dimensional information indicating a possibility that the object exists for each of a plurality of second points included in the plane, and
processing the two-dimensional information to detect a target region that is a region where the object has a possibility of existing in the subject region.
13. The information processing method according to any one of the above 9 to 12, in which
the subject region is a ground and an underground under the ground, and
the object exists on the ground or in the underground.
14. The information processing method according to any one of the above 9 to 13, further including
by the computer, detecting the plurality of target regions further by using at least one of geological information of the subject region and weather information when the reflected wave corresponding to each of the plurality of target regions is generated.
15. An information processing method including:
by a computer
processing reflected wave information indicating a reflected wave of an electromagnetic wave applied to a subject region to detect a plurality of target regions that are regions where an object has a possibility of existing in the subject region, and
generating and outputting map information in which positions of the plurality of target regions are displayed.
16. The information processing method according to the above 15, further including
by the computer, outputting a screen including an input field for inputting information for specifying a recommended investigation order in a case where whether the object exists is investigated again and the map information to be displayed on a display.
17. A program for causing a computer to:
process reflected wave information indicating a reflected wave of an electromagnetic wave applied to a subject region to detect a plurality of target regions that are regions where an object has a possibility of existing in the subject region, and
determine a recommended investigation order in a case where whether the object exists is investigated again by using positions of each of the plurality of target regions.
18. The program according to the above 17, in which
a frequency of the electromagnetic wave is equal to or more than 0.3 GHz and equal to or less than 300 GHz.
19. The program according to the above 17 or 18, in which
the reflected wave information is generated by a flying object or a self-propelled device including an irradiation means for applying the electromagnetic wave and a receiving means for receiving the reflected wave.
20. The program according to any one of the above 17 to 19, further causing the computer to:
process reflected wave information indicating a reflected wave of an electromagnetic wave applied to a subject region to generate three-dimensional information indicating a possibility that an object exists for a plurality of first points included in a three-dimensional space corresponding to the subject region,
project the three-dimensional information onto a predetermined plane to generate two-dimensional information indicating a possibility that the object exists for each of a plurality of second points included in the plane, and
process the two-dimensional information to detect a target region that is a region where the object has a possibility of existing in the subject region.
21. The program according to any one of the above 17 to 20, in which
the subject region is a ground and an underground under the ground, and
the object exists on the ground or in the underground.
22. The program according to any one of the above 17 to 21, further causing the computer to:
detect the plurality of target regions further by using at least one of geological information of the subject region and weather information when the reflected wave corresponding to each of the plurality of target regions is generated.
23. A program for causing a computer to:
process reflected wave information indicating a reflected wave of an electromagnetic wave applied to a subject region to detect a plurality of target regions that are regions where an object has a possibility of existing in the subject region, and
generate and output map information in which positions of the plurality of target regions are displayed.
24. The program according to the above 23, further causing the computer to output a screen including an input field for inputting information for specifying a recommended investigation order in a case where whether the object exists is investigated again and the map information to be displayed on a display.
25. A recording medium recorded with the program according to any one of the above 17 to 24.

This application is based upon and claims the benefit of priority from Japanese Patent Application No. 2023-055108, filed on Mar. 30, 2023, the disclosure of which is incorporated herein in its entirety by reference.

### REFERENCE SIGNS LIST

10 information processing device
20 measurement device
110 communication unit
120 three-dimensional information generation unit
130 two-dimensional information generation unit
140 detection unit
150 storage unit
160 reflected wave information processing unit
170 reflected wave processing unit
180 order determination unit
190 output unit
210 electromagnetic transmitting unit
220 electromagnetic receiving unit
230 reflected wave information generation unit
240 communication unit

What is claimed is:

1. An information processing device comprising:
at least one memory storing instructions; and
at least one processor configured to execute the instructions to:
process reflected wave information indicating a reflected wave of an electromagnetic wave applied to a subject region to detect a plurality of target regions that are regions where an object has a possibility of existing in the subject region; and
determine a recommended investigation order in a case where whether the object exists is investigated again by using positions of each of the plurality of target regions.

2. The information processing device according to claim 1, wherein
a frequency of the electromagnetic wave is equal to or more than 0.3 GHZ and equal to or less than 300 GHz.

3. The information processing device according to claim 1, wherein
the reflected wave information is generated by a flying object or a self-propelled device comprising an irradiation unit that applies the electromagnetic wave and a receiving unit that receives the reflected wave.

4. The information processing device according to claim 1, wherein
processing the reflected wave information comprises:
generating, based on the reflected wave information, three-dimensional information indicating a possibility that an object exists for a plurality of first points included in a three-dimensional space corresponding to the subject region;
generating by projecting the three-dimensional information onto a predetermined plane, two-dimensional information indicating a possibility that the object exists for each of a plurality of second points included in the plane; and
detecting, by processing the two-dimensional information, a target region that is a region where the object has a possibility of existing in the subject region.

5. The information processing device according to claim 1, wherein
the subject region is a ground and an underground under the ground, and
the object exists on the ground or in the underground.

6. The information processing device according to claim 1, wherein
processing the reflected wave information comprises detecting the plurality of target regions further by using at least one of geological information of the subject region and weather information when the reflected wave corresponding to each of the plurality of target regions is generated.

7.-8. (canceled)

9. An information processing method comprising:
by a computer
processing reflected wave information indicating a reflected wave of an electromagnetic wave applied to a subject region to detect a plurality of target regions that are regions where an object has a possibility of existing in the subject region; and
determining a recommended investigation order in a case where whether the object exists is investigated again by using positions of each of the plurality of target regions.

10. The information processing method according to claim 9, wherein
a frequency of the electromagnetic wave is equal to or more than 0.3 GHZ and equal to or less than 300 GHz.

11. The information processing method according to claim 9, wherein
the reflected wave information is generated by a flying object or a self-propelled device comprising an irradiation unit that applies the electromagnetic wave and a receiving unit that receives the reflected wave.

12. The information processing method according to claim 9, further comprising:
by the computer
generating, based on the reflected wave information, three-dimensional information indicating a possibility that an object exists for a plurality of first points included in a three-dimensional space corresponding to the subject region;
generating, by projecting the three-dimensional information onto a predetermined plane, two-dimensional information indicating a possibility that the object exists for each of a plurality of second points included in the plane; and
detecting, by processing the two-dimensional information, a target region that is a region where the object has a possibility of existing in the subject region.

13. The information processing method according to claim 9, wherein
the subject region is a ground and an underground under the ground, and
the object exists on the ground or in the underground.

14. The information processing method according to claim 9, further comprising
by the computer, detecting the plurality of target regions further by using at least one of geological information of the subject region and weather information when the reflected wave corresponding to each of the plurality of target regions is generated.

15.-16. (canceled)

17. A non-transitory computer-readable medium recorded with a program for causing
a computer to execute operations comprising:
processing reflected wave information indicating a reflected wave of an electromagnetic wave applied to a subject region to detect a plurality of target regions that are regions where an object has a possibility of existing in the subject region; and
determining a recommended investigation order in a case where whether the object exists is investigated again by using positions of each of the plurality of target regions.

18. The non-transitory computer-readable medium according to claim 17, wherein
a frequency of the electromagnetic wave is equal to or more than 0.3 GHZ and equal to or less than 300 GHz.

19. The non-transitory computer-readable medium according to claim 17, wherein
the reflected wave information is generated by a flying object or a self-propelled device comprising an irradiation unit that applies the electromagnetic wave and a receiving unit that receives the reflected wave.

20. (canceled)

21. The non-transitory computer-readable medium according to claim 17, wherein the operations further comprise:
generating, based on the reflected wave information, three-dimensional information indicating a possibility that an object exists for a plurality of first points included in a three-dimensional space corresponding to the subject region,
generating, by projecting the three-dimensional information onto a predetermined plane, two-dimensional information indicating a possibility that the object exists for each of a plurality of second points included in the plane, and
detecting, by processing the two-dimensional information, a target region that is a region where the object has a possibility of existing in the subject region.

22. The non-transitory computer-readable medium according to claim 17, wherein
the subject region is a ground and an underground under the ground, and
the object exists on the ground or in the underground.

23. The non-transitory computer-readable medium according to claim 17, wherein the operations further comprise:
detecting the plurality of target regions further by using at least one of geological information of the subject region and weather information when the reflected wave corresponding to each of the plurality of target regions is generated.
